(19) United States
(12) Patent Application Publication
(10) Pub. No.: US 2024/0029521 A1
(43) Pub. Date: Jan. 25, 2024

(54) COMPUTERIZED SYSTEM AND METHOD FOR CONTROLLING AN ELECTRONIC ACCOUNT VIA EXECUTED BETTING SCHEMES

(71) Applicant: Las Vegas Gambler, LLC, Henderson, NV (US)

(72) Inventor: William Thurman Walters, Henderson, NV (US)

(73) Assignee: LAS VEGAS GAMBLER, LLC, Henderson, NV (US)

(21) Appl. No.: 18/357,024

(22) Filed: Jul. 21, 2023

Related U.S. Application Data
(60) Provisional application No. 63/391,601, filed on Jul. 22, 2022.

(51) Int. Cl. G07F 17/32; G06Q 50/34

(52) U.S. Cl. CPC G07F 17/3288; G06Q 50/34

(57) ABSTRACT

Disclosed is a framework that is configured for securely executing sports handicapping, betting, and money-management. The disclosed systems and methods provide computerized methodologies and mechanisms for offsetting the varying abilities or characteristics of participants in a sporting event in order to equalize or leverage chances of winning the bet/wager. In some embodiments, the framework can be implemented to effectuate secure management and/or control of electronic assets used for a wager. The framework can securely monitor assets and asset values of a user's account and, based on the applied handicapping and the outcome of the sporting event, can effectuate an electronic transfer of assets in relation to the user's account (e.g., add assets and/or deduct assets).

### CROSS-REFERENCE TO RELATED APPLICATIONS

This application claims priority to and benefit of U.S. Provisional Patent Application 63/391,601 filed on Jul. 22, 2022, entitled “Computerized System and Method for Controlling an Electronic Account Via Executed Betting Schemes,” the entire disclosure of which is hereby incorporated by reference for all purposes.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE DISCLOSURE

The present disclosure relates generally to sports betting and, more particularly, to mechanisms for executing betting schemes and managing a bankroll of a user.

### SUMMARY

Various embodiments of systems and methods for sports handicapping, betting and money-management are disclosed. Broadly speaking, a method for sports handicapping, betting, and money-management includes identifying, by a device, a sporting event, the sporting event comprising at least one participant and corresponding to a sport activity, and determining, by the device, handicap information related to the sporting event. The method may further include executing, by the device, a money-management plan in accordance with a user's asset account, and determining, by the device, a bet on the sporting event according to a betting scheme, the money-management plan, and the handicap information. In various embodiments, the method also includes determining, by the device, an outcome of the betting scheme based on an outcome of the sporting event, the determined outcome indicating whether the bet was successful in view of stated odds and terms of the bet, and the handicap information, and determining, by the device, an allocation of assets in the user's asset account based on the determined outcome.

### BRIEF DESCRIPTION OF THE DRAWINGS

The features, and advantages, of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of an embodiment of a betting system.

FIG. 2 is a block diagram of an embodiment of a wager engine.

FIG. 3 is a block diagram of a network system that includes a wager engine.

FIG. 4 is a block diagram of a computing system.

FIG. 5 is a flow diagram depicting an embodiment of a method for betting and money-management.

FIG. 6 is a flow diagram depicting an embodiment of a method for handicapping a sporting event.

### DETAILED DESCRIPTION OF EMBODIMENTS

Sports betting involves wagering money on the outcome of a sporting event and can come in different forms. A bettor can wager on which participant wins a given sporting event, how many total points the participants in a sporting event will score, how large a points difference between at least two competitors during a sporting event, and the like.

In addition to traditional betting venues in places like Las Vegas, a bettor can also make wagers using many online websites and mobile applications. The convenience of online betting has made it popular with many bettors who seek to improve the odds by shopping around to find a best deal.

Despite taking advantage of the many possible betting websites, mobile applications, venues, etc., an average bettor faces many disadvantages that can result in a significant loss over a period of time. The embodiments described herein may provide techniques for handicapping, betting, and money-management strategy that may improve the odds for a bettor.

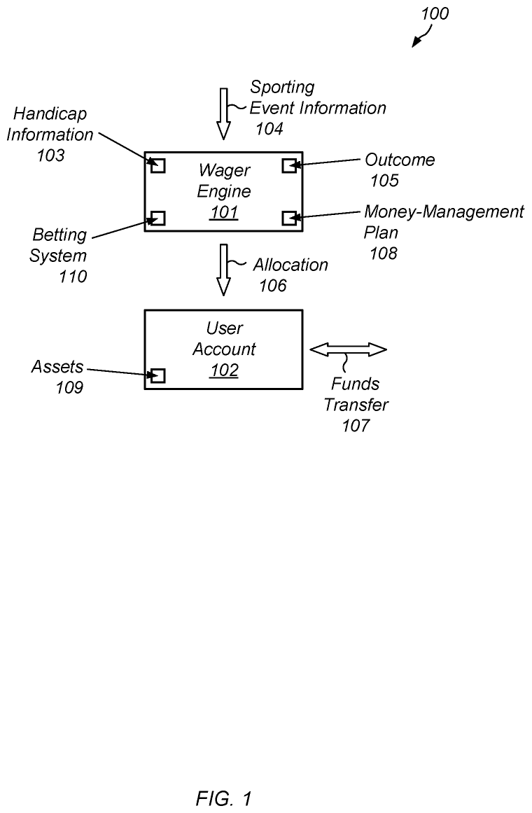

A block diagram of a betting system is depicted in FIG. 1. As illustrated, betting system 100 includes wager engine 101 and user account 102. As described below, all or part of betting system 100 may be implemented using any suitable combination of computer hardware and software.

Wager engine 101 is configured to identify a sporting event using sporting event information 104. In various embodiments, the sporting event may include at least one participant. The sporting event may, in different embodiments, correspond to a sporting activity.

Additionally, wager engine 101 is configured to determine handicap information 103, and execute money-management plan 108 in accordance with user account 102. In various embodiments, user account 102 may include information indicative of an amount of assets 109 associated with user account 102.

Wager engine 101 is further configured to determine a bet on the sporting event according to betting system 110, money-management plan 108, and handicap information 103. In various embodiments, wager engine 101 is further configured to place a bet on the sporting event 3.

Wager engine 101 is also configured to determine outcome 105 based on a result of the sporting event. In some embodiments, outcome 105 is indicative of whether the bet was successful in view of stated odds and terms of the wage, and the bettor's own determined handicap information. Additionally, wager engine 101 is also configured to generate allocation 106 based on result 105, and initiate funds transfer 107 based on allocation 106.

Although wager engine 101 is described as being used in conjunction with a sporting event, in other embodiments, wager engine 101 may be used with other types of wagers or bets. In some cases, wager engine 101 may be used to handicapped a series of events over a period time. For example, wager engine 101 may be employed to make a bet on whether or not a particular team will win a particular number of games during a season. Additionally, wager engine 101 may be used in conjunction with prop bets, such as a bet as to whether or not a particular play will achieve a certain performance statistic (e.g., yards, hits, runs, etc.) within a given game. It is noted that wager engine 101 can, in various embodiments and with determination of data needed by wager engine 101, be employed to wager on any suitable event, proposition, etc.

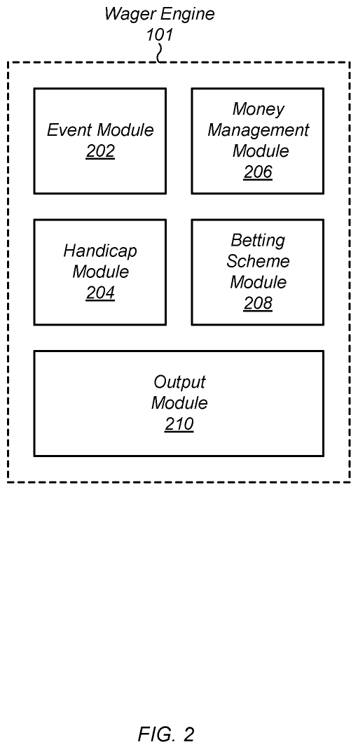

Turning to FIG. 2, a block diagram of an embodiment of wager engine 101 is depicted. As illustrated, wager engine 101 includes event module 202, handicap module 204, management module 206, betting scheme module 208, and output module 210.

For the purposes of this disclosure, a module is a software, hardware, or firmware (or combinations thereof) system, process or functionality, or component thereof, that performs or facilitates the processes, features, and/or functions described herein (with or without human interaction or augmentation). In various embodiments, a module can include sub-modules. Software components of a module may be stored on a computer readable medium for execution by a processor. Modules may be integral to one or more servers, or be loaded and executed by one or more servers. One or more modules may be grouped into an engine or an application.

It should be understood that the engine(s) and modules discussed herein are non-exhaustive, as additional or fewer engines and/or modules (or sub-modules) may be applicable to the embodiments of the systems and methods discussed.

Event module 202 is configured to identify a sporting event. In various embodiments, the sporting event can include at least one participant, and correspond to a sport activity. To identify the sporting event, event module 202 may be further configured to receive, from a user, a selected sport and a participant which may, in some embodiments, include a team, a player, and the like. In some cases, event module 202 may also be configured to identify an amount of a wager to be placed on the participant in the sporting event and/or the sporting event itself.

Handicap module 204 is configured to perform handicapping of the sporting event to determine a bettor's own handicap for the sporting event. In various embodiments, handicap module 204 may be configured to receive handicap information from an outside source such as a computer server. Alternatively, handicap module 204 may be configured to determine the bettor's own handicap for the sporting event independently of any received information. Handicap module 204 may be further configured to update the handicap information based on the outcome of the sporting event. As described below, handicap module 204 may perform a variety of operations, or steps, to determine a final handicap for a given sporting event. In various embodiments, handicap module 204 may add or subtract points from an initial number of points associated with a given participant in the sporting event.

Money management module 206 is configured to generate a money-management plan. In various embodiments, money management module 206 may be further configured to identify and execute the money-management plan. As described below, the money-management plan may include information indicative of a monetary unit that is a percentage of an overall amount of money available to wager. In some embodiments, wagers can be made using fractional portions of the monetary unit, while in other embodiments, wagers may be made using multiple whole monetary units. In various embodiments, the number of monetary units, either fractional or whole, may be based, at least in part, on a difference between the bettor's determined handicap and the spread for the sporting event.

Betting scheme module 208 is configured to determine a bet according to the bettor's determined handicap and the money-management plan. In various embodiments, the betting scheme can include information related, but not limited to, a bet on the sporting event, the money-management plan, handicap information, wager amount, user account information, user information, and the like, or any suitable combination thereof. In some embodiments, betting scheme module 208 is also configured to determine an amount to wager (in terms of monetary units) based on a strength of the predicted spread. In other embodiments, betting scheme module 208 may be further configured to determine whether or not the user or bettor should perform additional steps, such purchasing an additional half point to improve the odds of winning, switching from a spread to a money-line bet based on an associated cost of wagering, and the like.

Output module 210 is configured to place the bet on the sporting event. In some cases, to place the bet on the sporting event, output module 210 may be further configured to transmit or send instructions to a third party application.

In some embodiments, output module 210 is configured to determine an outcome of the bet. To determine the outcome, output module 210 may be further configured to analyze results of the sporting event, and determine whether the handicap information applied to the bet rendered the bet successful, i.e., whether the user's bet was a winner or a loser. In various embodiments, output module 210 may further consider stated odds and terms of the bet in determining whether the bet is successful.

Output module 210 is also configured to provide information to money management module 206 in order to allocate assets in the user's account. Using the supplied information, money management module 206 may be further configured to allocate assets based on success of the bet, amount of the wager, odds, handicapping information, type of bet (e.g., parlay), and the like.

In various embodiments, output module 210 is configured to perform transfer of assets. The success of the bet determines whether electronic assets are securely transferred to the user's account, or deducted from the user's account. In some embodiments, output module 210 may be configured to generate instructions that can cause an application or server associated with the user's account to grant permissions to output module 210 to control how the assets are allocated (e.g., modify a security layer and/or read/write access to the user's account). In some embodiments, the instructions can cause a server associated with the user's account to act in a manner that correlates with the determined allocation of assets. It is noted that, in some embodiments, output module 210 may send additional information to money management module 206 to allow money management module 206 to perform the transfer of assets.

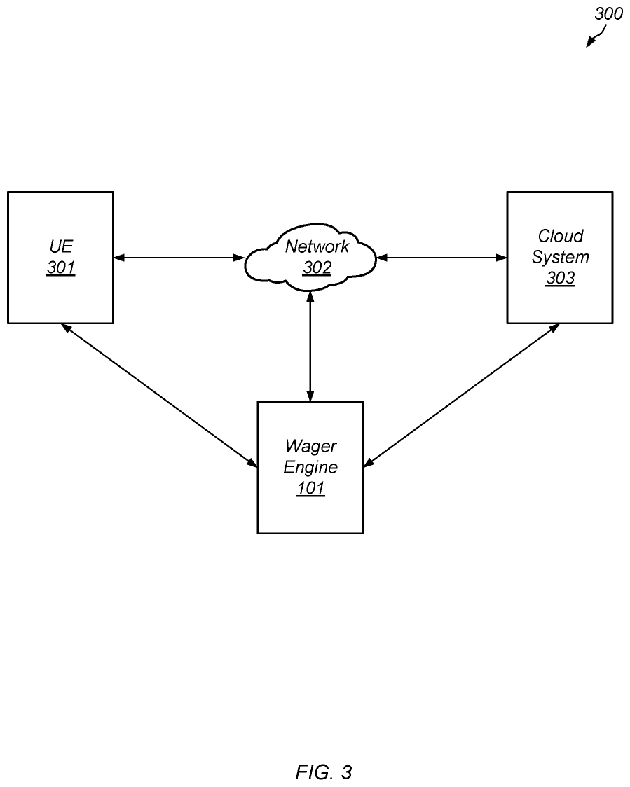

Turning to FIG. 3, a block diagram of a network system is depicted. As illustrated, network system 300 includes user equipment 301 (denoted as “UE 301”), network 302, cloud system 303, and wager engine 101.

UE 301 is configured to relay information from a user to wager engine 101. In some cases, UE 301 is configured to relay such information to wager engine 101 via network 302. Alternatively, UE 301 may be configured to relay such information via a direct wired or wireless connection to wager engine 101.

In various embodiments, UE 301 can be any type of device, such as, but not limited to, a mobile phone, tablet, laptop, personal computer, sensor, Internet of Things (IoT) device, autonomous machine, and any other device equipped with a cellular, wireless, or wired transceiver.

Network 302 can be any type of network, such as, but not limited to, a wireless network, cellular network, the Internet, and the like (as discussed above). As discussed herein, network 302 can facilitate connectivity of UE 301, wager engine 101, and cloud system 303 as depicted in FIG. 3.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular, or any combination thereof. Likewise, sub-networks, which may employ differing architectures, or may be compliant or compatible with differing protocols, may interoperate within a larger network.

Cloud system 303 can be any type of cloud operating platform and/or network based system upon which applications, operations, and/or other forms of network resources can be located. For example, cloud system 303 can correspond to a service provider, network provider and/or network platform from where services and/or applications can be accessed, sourced or executed. Alternatively, cloud system 303 can correspond to a sports betting platform (e.g., an online sports book, for example).

In some embodiments, cloud system 303 can include a server(s) and/or a database of information which is accessible over network 302. In some embodiments, a database (not shown) of cloud system 303 can be configured to store a set of data and metadata associated with local and/or network information related to a user(s) of UE 301, odds-makers, and the services and applications provided by cloud system 303 and/or wager engine 101.

In some embodiments, wager engine 101 can be a special purpose machine or processor and could be hosted by a device on network 302, within cloud system 303 and/or on UE 301. In some embodiments, wager engine 101 can be hosted by a peripheral device connected to UE 301.

In other embodiments, wager engine 101 can function as an application provided by cloud system 303. In other embodiments, wager engine 101 can function as an application installed on UE 301. Such an application can, in various embodiments, be a web-based application accessed by UE 301 over network 302 from cloud system 303 (e.g., as indicated by the connection between network 302 and wager engine 101, and/or the connection between UE 301 and wager engine 101). In some embodiments, wager engine 101 can be configured and/or installed as an augmenting script, program, or application (e.g., a plug-in or extension) to another application or program provided by cloud system 303 and/or executing on UE 301.

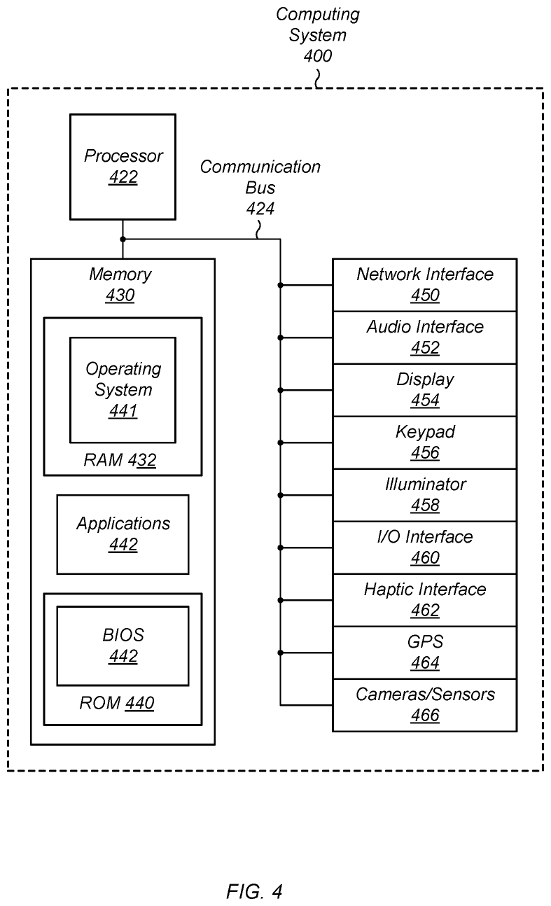

A block diagram of a computing system is depicted in FIG. 4. As illustrated, computing system 400 includes processor 422, memory 430, network interface 450, audio interface 452, display 454, keypad 456, illuminator 458, input/output (I/O) interface 460, haptic interface 462, GPS 464, and cameras/sensors 466. In various embodiments, computing system 400 may be used as part of an implementation of wager engine 110 or any other of the computing devices or servers described in this disclosure.

Computing system 400 may include more or fewer components than those shown in FIG. 4, depending on the deployment or usage of computer system 400. For example, a server computing system, such as a rack-mounted server, may not include audio interface 452, display 454, keypad 456, illuminator 458, haptic interface 462, GPS 464, or cameras/sensors 466. Some devices may include additional components not shown, such as graphics processing unit (GPU) devices, cryptographic co-processors, artificial intelligence (AI) accelerators, or other peripheral devices.

In some embodiments, processor 422 may be implemented as a general-purpose processor configured to retrieve program or software instructions from memory 430 via communication bus 424. Processor 422 may, in various embodiments, be implemented using one or more processor cores, microcontrollers, or other suitable combinations of combinatorial and sequential logic circuits.

In some embodiments, different components included in computing system 400 may be combined on a single integrated circuit to form a system-on-a-chip (SoC) or a similar embedded system. For example, network interface 450 and audio interface 452 may be combined with processor 422 on a single integrated circuit. It is noted that, in various embodiments, any suitable combination of components depicted in computing system 400 may be combined into a SoC for use in computing system 400.

In various embodiments, communication bus 424 may include multiple wires and be implemented using any suitable communication protocol. For example, communication bus 424 may employ a Peripheral Component Interconnect Express (PCIe) communication protocol. It is noted that although a single communication bus is depicted in the embodiment of FIG. 4, in other embodiments, multiple communication busses, employing respective communication protocols, may be used in computing system 400.

Memory 430 includes random-access memory (RAM) 432, which may be implemented using any suitable combination of dynamic random-access memory (DRAM) circuits, static random-access memory (SRAM) circuits, or Flash (e.g., NAND Flash) memory circuits. In various embodiments, memory 430 is an example of computer storage media for the storage of information such as computer-readable instructions, data structures, program modules, or other data. Memory 430 includes read-only memory (ROM) 440 that may, in various embodiments, be configured to store a basic input/output system (“BIOS”) 442 for controlling the low-level operation of computing system 400. Memory 430 may also be configured to store operating system 441 for controlling the operation of computing system 400.

Applications 442 may include computer-executable instructions which, when executed by computing system 400, perform any of the methods (or portions of the methods) described in this disclosure. In some embodiments, software or programs implementing the method embodiments can be read from a hard disk drive (not illustrated) and temporarily stored in random-access memory (RAM) 432 by processor 422. Additionally, processor 422 may be further configured to read software or data from RAM 432, process them, and store them to RAM 432 again.

Computing system 400 may be optionally configured to communicate with a base station (not shown) or directly with another computing device. Network interface 450 may be referred to as a transceiver, transceiving device, or network interface card (NIC).

Audio interface 452 is configured to produce and receive audio signals such as the sound of a human voice. For example, audio interface 452 may be coupled to a speaker and microphone (not shown) to enable telecommunication with others or generate an audio acknowledgment for some action.

Display 454 may be implemented using a liquid crystal display (LCD), gas plasma, light-emitting diode (LED), or any other suitable type of display used with a computing device. Display 454 may also be implemented using a touch-sensitive screen configured to receive input from an object such as a stylus or a digit from a human hand.

Keypad 456 may be implemented using any input device configured to receive input from a user. Illuminator 458 may be configured to generate a status indication or provide light.

I/O interface 460 is configured to communicate with external devices using any suitable communication technologies, such as USB, infrared, Bluetooth™, or the like. In various embodiments, haptic interface 462 may be configured to provide tactile feedback to a user of the client device.

GPS 464 can be configured to determine the physical coordinates of computing system 400 on the surface of the Earth, which typically outputs a location as latitude and longitude values. In various embodiments, GPS 464 can also be configured to employ other geo-positioning mechanisms including, but not limited to, triangulation, assisted GPS (AGPS), E-OTD, CI, SAI, ETA, BSS, or the like, to further determine the physical location of computing system 400 on the surface of the Earth. In some embodiments, computing system 400 may communicate through other components, provide other information that may be employed to determine a physical location of the device, including, for example, a MAC address, IP address, or the like.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

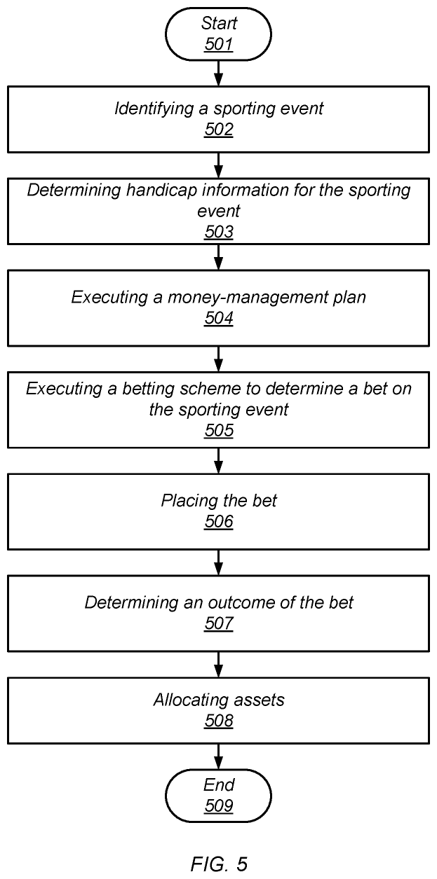

Turning to FIG. 5, a flow diagram depicting an embodiment of a method for making a wager on a sporting event according to a betting system is shown. The method, which may be applied to various computing devices and systems (e.g., wager engine 101) begins in block 501. It is noted that the operations depicted in the flow diagram of FIG. 5 may be performed by any suitable computing device such as a processor, one or more processor cores, a microcontroller, and the like.

The method includes identifying a sporting event (block 502). In various embodiments, the sporting event, which may correspond to a sports activity, includes at least one participant. In some embodiments, the at least one participant can include a single player, group of players, team, or any suitable participant in the sporting event.

The method also includes determining handicap information on the sporting event (block 503). In some embodiments, the handicap information may be received via a computer network, or may be provided to the computing system by a user, while in other embodiments, the handicap information may be determined independently of any outside information. In various embodiments, the method further includes handicapping the sporting event based on received handicap information. As described below, handicapping the sporting event can include multiple steps such as determining initial ratings for the participants in the sporting event.

The method further includes executing a money-management plan (block 504). In various embodiments, the money-management plan may include a maximum amount of money that can be invested in the betting process (referred to as a “bankroll”). The money-management plan may, in other embodiments, include a maximum amount of money to be wagered on a given single bet. For example, the maximum amount of money to be wagered on the given single bet may correspond to 1-3% of the bankroll.

In some cases, the money-management plan may also define a monetary unit (or simply “units”) that are used within a wager as a percentage of the bankroll. For example, a given wager may include a bet of 0.5 units to 4 units in increments of 0.5 units. It is noted that as the bankroll grows or shrinks based on the outcomes of bets, the amount of money associated with a given unit changes accordingly.

The method also includes executing a betting scheme (block 505). In some embodiments, the betting scheme can include information related to, but not limited to, a bet on the sporting event, the money-management plan, the handicap information, wager amount, user account information, user information, adjustments to a value of the bet or features based on a prediction of the outcome of the sporting event made using determined handicap information, and market data related to odd and pricing of a given wager by multiple market-makers (i.e., sports books), the like, or combinations thereof.

The method further includes placing the bet on the sporting event (block 506). In some embodiments, the bet placement can be effectuated via an application associated with the disclosed framework (e.g., wager engine 101). In other embodiments, the method may include causing a third party application to place the bet via instructions created and transferred by wager engine 101 to the third party application.

The method further includes determining an outcome of the bet (block 507). In some embodiments, determining the outcome of the bet can include analyzing results associated with the sporting event, and determining whether the handicap information, betting strategy, and features applied to the bet rendered the bet successful. In some embodiments, stated odds and terms of the bets may also be considered in determining the success of the bet.

The method also includes determining an allocation of assets in the user's asset account based on the outcome (block 508). In some embodiments, determining the allocation may be based on whether the bet was successful, an amount of the bet, odds associated with the bet, handicapping, type of bet, and the like. For example, a bet may be a parlay or a teaser, where the bet is based on the outcome of multiple sporting events. It is noted that, in some embodiments, determining the allocation may be performed by money management module 206.

The method may, in some embodiments, include performing asset allocation. In some embodiments, performing the asset allocation may include transferring assets from the user's account based on whether the bet was successful. Alternatively, performing the asset allocation may include deducting assets from the user's account based on whether the bet was successful. The method concludes in block 509.

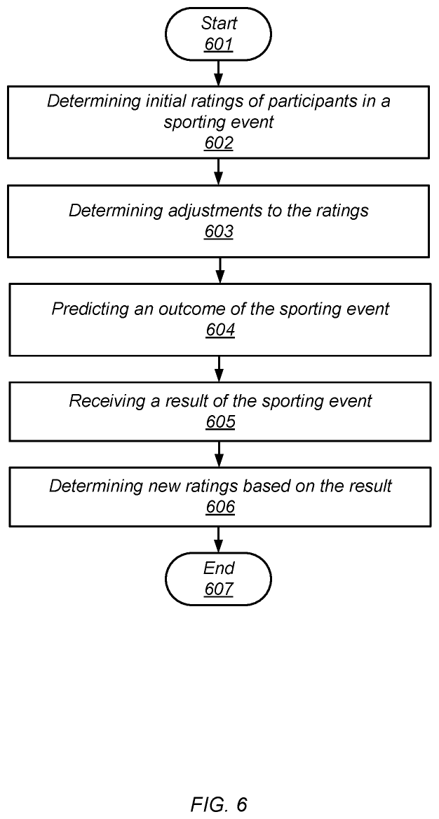

Turning to FIG. 6, a flow diagram depicting an embodiment of a method for handicapping a sporting event is illustrated. The method, which may be applied to various computing devices and systems (e.g., wager engine 101), begins in block 601. It is noted that, in various embodiments, all or some of the operations depicted in the flow diagram of FIG. 6 may be included as part of block 503 as depicted in the flow diagram of FIG. 5.

The method includes determining initial ratings of participants in a sporting event (block 602). In various embodiments, the initial ratings of the participants may correspond to numbers indicative of a relative strength between the participants. In some cases, past performance of a given participant may be used to determine the participant's initial rating for the sporting event.

The method further includes determining adjustments to the ratings (block 603). While the initial ratings may provide a metric as to the expected outcome of the sporting event, other factors may affect the ratings. In various embodiments, different factors, e.g., the location of where the sporting event is to be played, can be used to adjust the initial ratings. In some cases, the other factors may increase a value of an overall rating, while in other cases, the other factors may decrease the value of the overall rating.

There may exist other factors that can affect the overall rating for a given participant in a sporting event. For example, the location in which the sporting event is to be played can affect the outcome. In some embodiments, additional points are added to a participant's rating if the sporting event is to be played on the participant's home field. The additional points can range from 0.5 points to 3 points based on historical trends, geographic location, and the like.

Other factors can include game day weather conditions, participants schedules (e.g., byes, multiple away games in a row, etc.), and the like. In cases where a participant in a sporting event corresponds to a team that includes a plurality of players, respective ratings of the plurality of players can be used to determine the overall rating for the team. Additionally, illness or injury of a given player of the plurality of players can decrease the overall rating for the team.

The method also includes predicting an outcome of the sporting event (block 604). In various embodiments, predicting the outcome of the sporting event includes performing a comparison of the predicted outcome to a posted point spread. The method may include, in some embodiments, placing a bet or wager using a result of the comparison. In some cases, an amount of the bet or wager may be based, at least in part, on the result of the comparison.

The method further includes receiving a result of the sporting event (block 605). It is noted that even if the result of the sporting event is unfavorable, i.e., the bet or wager was unsuccessful, the resultant information can be used to make predictions regarding the outcome of future games that include the participants of the sporting events.

The method also includes determining new sporting event participant ratings based on the result (block 606). It is noted that the steps described above may be performed repeatedly for each new sporting event within a season associated with the sporting event. In various embodiments, results from a final sporting event of one season may be used to generate initial ratings for an initial game of a subsequent season. The method concludes in block 607.

The disclosed subject matter may be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The foregoing detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as “up,” “down,” “bottom,” “top,” “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately,” are understood by those skilled in the art to refer to reasonable ranges around and including the given value and ranges outside the given value, for example, general tolerances associated with manufacturing, assembly, and use of the embodiments. The term “substantially,” when referring to a structure or characteristic, includes the characteristic that is mostly or entirely present in the characteristic or structure.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes, without limitation, volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device, referred to as user equipment (UE)), may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Near Field Communication (NFC) device, a Personal Digital Assistant (PDA), a handheld computer, a tablet computer, a phablet, a laptop computer, a set top box, a wearable computer, a smart watch, an integrated or distributed device combining various features, such as features of the forgoing devices, and the like.

For the purposes of this disclosure, the term “user”, “bettor”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered, and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method, comprising:
identifying, by a device, a sporting event, the sporting event comprising at least one participant and corresponding to a sport activity;
determining, by the device, handicap information related to the sporting event;
executing, by the device, a money-management plan in accordance with a user's asset account;
determining, by the device, a bet on the sporting event according to a betting scheme, the money-management plan, and the handicap information;
placing, by the device, the bet;
determining, by the device, an outcome of the bet based on outcome result of the sporting event, wherein the outcome indicates whether the bet was successful in view of stated odds and terms of the bet, and the handicap information; and
determining, by the device, an allocation of assets in the user's asset account based on the determined outcome.

2. The method of claim 1, further comprising performing, by the device, an electronic transfer of assets using the user's asset account and based on the allocation.

3. The method of claim 1, further comprising updating the handicap information based on the outcome of the sporting event.

4. The method of claim 3, wherein updating the handicap information includes:
determining initial ratings associated with the at least one participant; and
adjusting the initial ratings to generate modified ratings.

5. The method of claim 4, wherein adjusting the initial ratings includes adjusting the initial ratings based on any injuries to the at least one participant.

6. The method of claim 4, further comprising:
predicting a result of the sporting event using the modified ratings; and
determining new ratings based on a comparison of the result and the outcome of the sporting event.

7. An apparatus, comprising:
a processor configured to:
identify a sporting event, the sporting event comprising at least one participant and corresponding to a sport activity;
determine handicap information related to the sporting event;
execute a money-management plan in accordance with a user's asset account;
determine a bet on the sporting event according to a betting scheme, the money-management plan, and the handicap information;
determine an outcome of the bet based on a result of the sporting event, wherein outcome indicates whether the bet was successful in view of stated odds and terms of the bet, and the handicap information; and
determine an allocation of assets in the user's asset account based on the determined outcome.

8. The apparatus of claim 7, wherein the processor is further configured to perform an electronic transfer of assets using the user's asset account and based on the allocation

9. The apparatus of claim 7, wherein to identify the sporting event, the processor is further configured to receive a selection by the user via user equipment (UE).

10. The apparatus of claim 7, wherein the processor is further configured to update the handicap information based on the outcome of the sporting event.

11. The apparatus of claim 10, wherein to update the handicap information, the processor is further configured to:
determine initial ratings associated with the at least one participant; and
adjust the initial ratings to generate modified ratings.

12. The apparatus of claim 11, wherein to adjust the initial ratings, the processor is further configured to adjust the initial ratings based on any injuries to the at least one participant.

13. The apparatus of claim 11, wherein the processor is further configured to:
predict a result of the sporting event using the modified ratings; and
determine new ratings based on a comparison of the result and the outcome of the sporting event.

14. A non-transitory computer-readable storage medium having program instructions stored therein that, in response to execution by a computer system, causes the computer system to perform operations comprising:
identifying, by the device, a sporting event, the sporting event comprising at least one participant and corresponding to a sport activity;
determining, by the device, handicap information related to the sporting event;
executing, by the device, a money-management plan in accordance with a user's asset account;
determining, by the device, a bet on the sporting event according to a betting scheme, the money-management plan, and the handicap information;
determining, by the device, an outcome of the betting scheme based on outcome result of the sporting event, wherein the outcome indicates whether the bet was successful in view of stated odd and terms of the bet, and the handicap information; and
determining, by the device, an allocation of assets in the user's asset account based on the determined outcome.

15. The tangible non-transitory computer-readable storage medium of claim 14, wherein the operations further comprise performing an electronic transfer of assets using the user's asset account and based on the allocation.

16. The tangible non-transitory computer-readable storage medium of claim 14, wherein the operations further comprise updating the handicap information based on the outcome of the sporting event.

17. The tangible non-transitory computer-readable storage medium of claim 16, wherein updating the handicap information includes:
determining initial ratings associated with the at least one participant; and
adjusting the initial ratings to generate modified ratings.

18. The tangible non-transitory computer-readable storage medium of claim 17, wherein adjusting the initial ratings includes adjusting the initial ratings based on any injuries to the at least one participant.

19. The tangible non-transitory computer-readable storage medium of claim 17, wherein the operations further comprise:
predicting a result of the sporting event using the modified ratings; and
determining new ratings based on a comparison of the result and the outcome of the sporting event.

20. The tangible non-transitory computer-readable storage medium of claim 17, wherein adjusting the initial ratings includes adjusting the initial ratings based on a location where the sporting event is to be held.
